(19) United States
(12) Patent Application Publication
(10) Pub. No.: US 2012/0122067 A1
(43) Pub. Date: May 17, 2012

(54) ONLINE EDUCATIONAL SYSTEM WITH MENTOR GUIDED LEARNING

(75) Inventors: Doug Dohring, Glendale, CA (US); William McCaffrey, Glendale, CA (US); Stephanie Yost, Glendale, CA (US); David Hendry, La Crescenta, CA (US); Lee Borth, Sunland, CA (US); Nathan Drobnack, Glendale, CA (US)

(73) Assignee: AGE OF LEARNING, INC., Glendale, CA (US)

(21) Appl. No.: 12/946,627

(22) Filed: Nov. 15, 2010

(51) Int. Cl. G09B 7/00

(52) U.S. Cl. 434/322

(57) ABSTRACT

An educational system assembling platform comprising a digital processing device connected to a computer network and a computer program, provided to said digital processing device via said network. The digital processing device comprises an operating system configured to perform executable instructions, a central processing unit, a memory device, a display, an input device, and a sound output device. The computer program includes executable instructions that create an educational environment. The educational environment comprises at least one area of skill, interest, or expertise, a plurality of learning activities associated with each area of skill, interest, or expertise, and a mentor guided learning mode. The mentor guided learning mode comprises a software module, adapted for a mentor, for selecting one or more learners, a software module, adapted for a mentor, for selecting learning activities from among said population of activities to create one or more subpopulations of activities to be completed by a learner, and a software module, adapted for a learner, for displaying and providing access to one or more subpopulations of learning activities to be completed by a learner.

### BACKGROUND OF THE INVENTION

Higher levels of education offer benefits, both intangible and economic, for students and the societies in which they live. Personal benefits can include a feeling of fulfillment, social and economic mobility, and increased quality of life. According to the Census Bureau, over an adult's working life, high school graduates earn an average of $1.2 million; associate's degree holders earn about $1.6 million; and bachelor's degree holders earn about $2.1 million. On a larger scale, countries with high enrollment and graduation rates have grown faster than countries without.

Effective educational experiences are important at all stages of life. Preschool education develops the foundation for children's enduring language, motor, and analytical skills. Primary education helps children achieve basic literacy and numeracy, and establishes foundations in science, mathematics, geography, history, and other social sciences. Secondary education provides adolescents opportunities to learn in areas beyond traditional basic subjects including foreign languages, advanced math, advanced science, and advanced humanities. Importantly, secondary education also prepares students for the transition to higher education as adults. Higher education provides specialized academic, professional, or vocational training, resulting in award of certificates, diplomas, or academic degrees. In professional life, education enables adults to advance within their career or re-train to support a career change. Even in post-career life, seniors enjoy the benefits of education in pursuit of hobbies and personal interests.

Educational subjects and the reasons for undertaking education vary greatly at different stages of life. Moreover, every individual learns differently. Therefore, effective educational experiences should provide every learner with opportunities to interact with customized learning content. In educational environments, mentors provide expertise to less experienced individuals to help them enhance their learning. Mentors can provide the insight necessary to customize learning content to meet the needs of individual learners.

### SUMMARY OF THE INVENTION

Technology offers educators new opportunities to create powerful learning tools. For example, multimedia provides new ways to interact with learners, such as interactive online educational environments. In such an environment, mentors can be provided with tools to leverage their experience and knowledge of each learner in order to customize the educational experience. All learners need not experience identical sequences of learning activities. For these reasons, an effective educational environment should provide features and functionality that allow mentors to bring their experience and knowledge of each learner to bear in the design of customized lessons, units, and levels of study.

Despite the potential for customized content and mentor involvement in structuring learning content created by technology, current online educational environments offer little opportunity for customization and just as little opportunity for mentor involvement. Accordingly, we have identified a long-felt and unmet need for an online educational environment that offers a mentor guided learning mode. Such a mode should provide features and functionality to enable mentors to select one or more learners, select learning activities from among a population to create one or more subpopulations of activities, display one or more subpopulations of activities to learners and provide them access to the learning activities. And, in some embodiments, the mode should allow mentors and learners to monitor the progress of learners as they complete activities and subpopulations of activities.

Disclosed herein are computer-based educational system assembling platforms, methods of education, and media encoded with computer programs. In some embodiments, the computer-based educational system assembling platforms are intranet-based. In some embodiments, the assembling platforms are Internet-based. In further embodiments, the assembling platforms are World Wide Web-based. In still further embodiments, the assembling platforms are cloud computing-based. In other embodiments, the assembling platforms are based on data storage devices including, by way of non-limiting examples, CD-ROMs, DVDs, flash memory devices, magnetic disk drives, and optical disk drives.

In some embodiments, the computer-based educational system comprises a digital processing device connected to a computer network and a computer program including executable instructions that create an educational environment. The digital processing device comprises an operating system configured to perform executable instructions, a central processing unit, a memory device, a display, a sound output device, and an input device. The computer program includes executable instructions that create an educational environment comprising at least one area of skill, interest, or expertise, and a plurality of activities associated with each area of skill, interest, or expertise. The educational environment further comprises a mentor guided learning mode.

One aspect of the educational system assembling platform disclosed herein is a software module, adapted for use by a mentor, for selecting one or more learners. In some embodiments, the mentor creates an account within the educational system. In further embodiments, a mentor associates one or more learners with their account. In some embodiments, a mentor selects one learner for whom to configure a customized sequence of learning activities. In further embodiments, a mentor selects more than one learner. In various embodiments, mentors can select learners in a multitude of ways. In some embodiments, a mentor selects one or more learners by selecting learners' names, selecting learners' avatars, or by typing learners' names. In some embodiments, a mentor selects one or more learners based on characteristics such as, previous completion of specific learning activities, performance in previous learning activities, or interests and preferences of the learners.

Another aspect of the educational system assembling platform disclosed herein is a software module, adapted for use by a mentor, for selecting learning activities from among a population of activities to create one or more subpopulations of activities to be completed by one or more learners. In various embodiments, mentors can identify learning activities in a multitude of ways. In some embodiments, the software module for selecting learning activities is configured to allow a mentor to identify activities by area of skill, interest, or expertise. In various embodiments, the software module for selecting learning activities is configured to allow a mentor to identify activities by activity type, activity theme, activity duration, or level of skill required. In some embodiments, the software module for selecting learning activities is configured to allow a mentor to identify activities that teach to a particular educational objective. In some embodiments, the software module for selecting learning activities is configured to allow a mentor to identify activities that teach to a particular element of a published educational standard. In further embodiments, the software module for selecting learning activities is configured to allow a mentor to identify activities by keyword searching. In various embodiments, mentors can select learning activities and add them to a subpopulation of activities in a multitude of ways such as clicking activity icons, dragging and dropping activity icons into a designated area, checking check boxes associated with activities, or typing the names of activities. In some embodiments, the educational system assembling platform further comprises a software module for creating, naming, and saving multiple subpopulations of learning activities associated with one or more learners. In some embodiments, the software module for selecting learning activities is configured to allow a mentor to remove one or more activities from a subpopulation of activities. In some embodiments, a mentor removes activities by dragging and dropping activity icons into a designated area. In some embodiments, the software module for selecting learning activities is configured to allow said mentor to block one or more activities to prevent a learner from accessing those activities.

In some embodiments, the educational system assembling platform disclosed herein further comprises a software module, adapted for use by a mentor, for displaying and further organizing one or more subpopulations of learning activities. In some embodiments, the software module for displaying and organizing one or more subpopulations of learning activities is configured to allow said mentor to sort subpopulations of activities based on each activity's association with one or more areas of skill, interest, or expertise. In some embodiments, the software module for displaying and organizing one or more subpopulations of learning activities is configured to allow said mentor to sort subpopulations of activities based on the degree to which each activity teaches to a particular educational objective. In some embodiments, the software module for displaying and organizing one or more subpopulations of learning activities is configured to allow said mentor to sort subpopulations of activities based on the degree to which each activity addresses a particular element of a published educational standard. In some embodiments, the software module is configured to allow said mentor to sequence, rank, or prioritize activities within subpopulations of activities. In various embodiments, mentors can sequence learning activities in a multitude of ways such as dragging and dropping activity icons, typing a number associated with each activity, or using a pull down menu to assign a number. In some embodiments, the software module for displaying and organizing one or more subpopulations of learning activities is configured to allow said mentor to remove activities from subpopulations of activities. In further embodiments, a mentor removes activities by dragging and dropping them into a designated area. In some embodiments, the software module for displaying and organizing one or more subpopulations of learning activities is configured to display the number of times said learner has completed each activity.

Another aspect of the educational system assembling platform disclosed herein is a software module, adapted for use by a learner, for displaying and providing access to one or more subpopulations of learning activities to be completed by a learner. In some embodiments, the software module for displaying and providing access to one or more subpopulations of learning activities displays a single subpopulation of activities. In other embodiments, the software module displays more than one subpopulation of activities. In further embodiments, the software module displays a list of named subpopulations of activities. In some embodiments, the software module for displaying and providing access to one or more subpopulations of learning activities is configured to allow a learner to sort subpopulations of activities based on each activity's association with one or more areas of skill, interest, or expertise. In some embodiments, the software module for displaying and providing access to one or more subpopulations of learning activities is configured to allow a learner to sort subpopulations of activities based on the degree to which each activity teaches to a particular educational objective. In some embodiments, the software module for displaying and providing access to one or more subpopulations of learning activities is configured to allow a learner to sort subpopulations of activities based on the degree to which each activity addresses a particular element of a published educational standard. In some embodiments, the software module for displaying and providing access to one or more subpopulations of learning activities is configured to allow a learner to freely select learning activities from among subpopulations of activities. In other embodiments, the software module is configured to require learners to complete a subpopulation of learning activities in the sequence determined by said mentor. In either configuration, in some embodiments, a learner has the option to repeat previously completed learning activities. In various embodiments, learners can select learning activities and access them in a multitude of ways such as clicking activity icons, double-clicking activity icons, hovering a pointer over activity icons, dragging and dropping activity icons, or typing the names of activities. In some embodiments, the software module for displaying and providing access to one or more subpopulations of learning activities is configured to display the number of times a learner has completed each activity. In some embodiments, the software module for displaying and providing access to one or more subpopulations of learning activities is configured to allow a learner to optionally remove learning activities from subpopulations of activities. In further embodiments, a learner may optionally remove learning activities from subpopulations based on criteria such as each activity's association with one or more areas of skill, interest, or expertise, activity type, or activity theme.

In some embodiments, the educational system assembling platform disclosed herein further comprises a software module, adapted for use by a mentor, for monitoring the progress of a learner in completing one or more subpopulations of activities. In some embodiments, the software module for monitoring the progress of a learner in completing one or more subpopulations of activities includes a visual indicator adapted for use by a learner, wherein said visual indicator displays the percentage of activities completed within a subpopulation of activities. In various embodiments, the visual indicator is in the form of a bar chart, pie chart, or a numeric percentage. In some embodiments, the software module for monitoring the progress of a learner in completing one or more subpopulations of activities includes progress displays adapted for use by a learner or a mentor to a learner. In further embodiments, the progress displays indicate metrics such as percentage completion of one or more subpopulations of activities, performance in one or more subpopulations of activities, and time spent in one or more subpopulations of activities. In still further embodiments, the progress displays indicate metrics such as completion of each activity associated with each subpopulation of activities, performance in each activity associated with each subpopulation of activities, and time spent in each activity associated with each subpopulation of activities. In still further embodiments, the progress displays indicate completion of one or more subpopulations of activities that teach to a particular educational objective, performance in one or more subpopulations of activities that teach to a particular educational objective, and time spent in one or more subpopulations of activities that teach to a particular educational objective. In still further embodiments, the progress displays indicate completion of one or more subpopulations of activities that address a particular element of a published educational standard, performance in one or more subpopulations of activities that address a particular element of an educational standard, and time spent in one or more subpopulations of activities that address a particular element of a published educational standard. In some embodiments, the software module for monitoring the progress of a learner in completing one or more subpopulations of activities includes printable reports adapted for use by a learner or a mentor to a learner.

The term “learner” as used herein, refers to a person of any age who interacts with an educational system for the purpose of gaining knowledge, insight, or understanding of one or more areas of skill, interest, or expertise or by virtue of having been allowed, asked, or assigned to interact with an educational system.

The term “mentor” as used herein, refers to a person who has an interest in, or responsibility for, facilitating or furthering the educational development of a learner and includes, by way of non-limiting examples, a parent, step-parent, adoptive parent, foster parent, grandparent, guardian, relative, friend, guide, instructor, teacher, or professor, of a learner.

The term “instructional designer” as used herein, refers to any person who designs and/or evaluates learning activities, and grouped sequences of activities, that are elements of an educational system.

The term “instructional plan” as used herein, refers to a plan, conceived by an instructional designer or a mentor to a learner, designed to accomplish one or more specific educational objectives through the mutual reinforcement of individual activities.

The term “lesson” as used herein, refers to one or more learning activities that teach toward a specific educational objective or a specific element of a published educational standard.

The term “learning unit” as used herein, refers to one or more lessons that teach toward a general educational objective or a general element of a published educational standard.

The term “level of study” as used herein, refers to one or more learning units that teach toward a plurality of general educational objectives or an overarching element of a published educational standard.

### BRIEF DESCRIPTION OF THE DRAWINGS

FIG. 1 shows a feature for use by a mentor in creating customized learning content; in this case, a lesson builder providing functionality for selecting one or more learners 1, identifying learning activities by area of skill, interest, or expertise 2, identifying learning activities by activity type 3, identifying learning activities by keyword searching 4, adding learning activities to subpopulations by dragging activity icons 6 to a designated area 5, further organizing 7 subpopulations of activities, blocking activities by dragging activity icons to a designated area 8, and removing activities from subpopulations by dragging activity icons to a designated area 9.

FIG. 2 shows a feature for use by a mentor in displaying and organizing one or more subpopulations of learning activities; in this case, a feature providing functionality for sorting subpopulations of activities based on each activity's association with one or more areas of skill, interest, or expertise 10, 11, sequencing activities within subpopulations of activities by dragging and dropping activity icons 12, removing activities from subpopulations of activities 13, and displaying the number of times a learner has completed each activity with a numeric counter 14 and a graphic icon 15.

FIG. 3 shows a feature for displaying and providing access to one or more subpopulations of learning activities to be completed by a learner; in this case, a feature providing functionality for sorting subpopulations of activities based on each activity's association with one or more areas of skill, interest, or expertise 16, accessing learning activities by selectable activity icons 17, and displaying the number of times a learner has completed each activity with a numeric counter 18 and a graphic icon 19.

### DETAILED DESCRIPTION OF THE INVENTION

Existing educational systems do not offer learners adequate opportunities to benefit from customized learning content nor do they provide powerful tools to facilitate the involvement of mentors in the design of customized educational content. Thus, a primary objective of the educational system assembling platforms, methods of education, and media encoded with computer programs disclosed herein is to facilitate and enhance the education of learners by providing every learner with opportunities to interact with customized learning content. Another objective is to provide features and functionality that allow mentors to bring their experience and knowledge of each learner to bear in the design of customized lessons, units, and levels of study. Advantages include, but are not limited to, more immersive, customized educational experiences for learners and mentors who are enabled to inject the insight necessary to customize learning content to meet the needs of individual learners.

### Educational System Assembling Platform

Disclosed herein is an educational system assembling platform comprising a digital processing device connected to a computer network and a computer program provided to the digital processing device via the network. The digital processing device comprises an operating system configured to perform executable instructions, a central processing unit, a memory device, a display, an input device, and a sound output device. The computer program includes executable instructions that create an educational environment that comprises at least one area of skill, interest, or expertise, a plurality of learning activities associated with each area of skill, interest, or expertise, and a mentor guided learning mode. The mentor guided learning mode comprises a software module, adapted for use by a mentor, for selecting one or more learners, a software module, adapted for use by a mentor, for selecting learning activities from among said population of activities to create one or more subpopulations of activities to be completed by a learner, and a software module, adapted for use by a learner, for displaying and providing access to one or more subpopulations of learning activities to be completed by a learner.

### Digital Processing Device

The educational system assembling platform disclosed herein includes a digital processing device. The digital processing device includes one or more hardware central processing units (CPU) that carry out the device's functions. The digital processing device further comprises an operating system configured to perform executable instructions, a memory device, a display, a sound output device, and an input device. In some embodiments, the digital processing device is connected to the Internet such that it can access the World Wide Web. In other embodiments, the digital processing device is connected to an intranet. In other embodiments, the digital processing device is connected to a data storage device.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

The digital processing device includes a memory device. The memory is one or more physical apparatus used to store data or programs on a temporary or permanent basis. In some embodiments, the memory is volatile and requires power to maintain stored information. In some embodiments, the memory is non-volatile and can retain stored information when the digital processing device is not powered.

The digital processing device includes a display to send visual information to a learner. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

The digital processing device includes a sound output device to send auditory information to a learner. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

The digital processing device includes an input device to receive information from a learner. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In accordance with the description herein, suitable digital processing devices include, by way of non-limiting examples, desktop computers, laptop computers, notebook computers, net book computers, set top computers, handheld computers, Internet appliances, mobile smart phones, tablet computers, and video game consoles. Those of skill in the art will recognize that many Internet connected mobile phones are suitable for use in the system described herein. Suitable tablet computers include those with booklet, slate, and convertible configurations, known to those of skill in the art.

### Computer Network

The educational system assembling platform disclosed herein includes a digital processing device connected to a computer network and a computer program that is provided to the device via the network. A computer network is a collection of computers and devices interconnected by communications channels that facilitate communications among users and allows users to share resources. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program is provided to the digital processing device via the Web. In still further embodiments, Internet provides access to the World Wide Web and the computer program is provided to the digital processing device via cloud computing. In other embodiments, the computer network comprises data storage devices including, by way of non-limiting examples, CD-ROMs, DVDs, flash memory devices, magnetic disk drives, and optical disk drives. In further embodiments, the computer program is provided to the digital processing device via a data storage device.

### Computer Program

The educational system assembling platform disclosed herein includes a computer program executable by a digital processing system that creates an educational environment. The computer program includes a sequence of instructions, executable in the digital processing device's CPU, written to perform a specified task. In the case of the educational system disclosed herein, the task is to create an educational environment. In other embodiments, the sequence of instructions is delivered to the digital processing system via an intranet. In some embodiments, the sequence of instructions is delivered to the digital processing system via the World Wide Web. In other embodiments, the sequence of instructions is delivered to the digital processing system via a data storage device. Those of skill in the art will recognize that the computer program may be written in various versions of various languages. The computer program may be written in one or more markup languages, style languages, client-side scripting languages, server-side coding languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a style language such as Cascading Style Sheets (CSS). In some embodiments, the computer program is written to some extent in a client-side scripting language such as Asynchronous Javascript and XML (AJAX), Flash®, Actionscript, Javascript, or Silverlight®. In some embodiments, the computer program is written to some extent in a server-side coding language such as Active Server Pages (ASP), ColdFusion®, Common Gateway Interface (CGI), Perl, Java™, Hypertext Preprocessor (PHP), Python™, Ruby, Structured Query Language (SQL), mySQL™, Oracle®, or .NET.

### Areas of Skill, Interest, or Expertise

The educational system assembling platform disclosed herein includes at least one area of skill, interest, or expertise. An area of skill, interest, or expertise may include informal topics such as those relating to hobbies and personal interests. A hobby is an activity or interest usually undertaken for pleasure or relaxation. An area of skill, interest, or expertise may also include more formal subjects addressing academic or professional topics. A subject is a category of learning that a student may typically undertake in an educational institution. In some embodiments, subjects comprise topics addressing one category of learning. In other embodiments, subjects comprise interdisciplinary topics addressing more than one category of learning. An area of skill, interest, or expertise may also include topics such as those relating to professional skills. Some professional skills are not taught as formal subjects, nor are they hobbies undertaken for relaxation, rather they are topics undertaken for business purposes.

In some embodiments, one or more areas of skill, interest, or expertise are selected from hobbies and personal interests including, by way of non-limiting examples, animal husbandry, animal breeding, antiquing, artistic endeavors, automobile restoration, automobile repair, bird watching, collecting, cooking, creating dioramas, fish keeping, fishing, flower arranging, game playing, gardening, horticulture, investing, knitting, origami, outdoor recreation, performing arts, poetry, quilting, reading, sewing, scale modeling, scrapbooking, wine tasting, writing, and yoga. In some embodiments, artistic endeavors include endeavors such as drawing, glass blowing, painting, sculpting, photography, and pottery. In some embodiments, collecting includes collecting art, coins, dolls, figurines, stamps, spoons, sports cards, and toys. In some embodiments, outdoor recreation includes activities such as backpacking, bicycling, canoeing, caving, climbing, hiking, running, snow sports, and water sports. In some embodiments, performing arts include activities such as acting, dancing, singing, juggling, magic, and playing musical instruments. In some embodiments, reading includes reading materials such as books, comics, magazines, and newspapers. In some embodiments, scale modeling includes subject matter such as automobiles, planes, ships, and trains.

In some embodiments, one or more areas of skill, interest, or expertise are selected from basic subjects including, by way of non-limiting examples, reading and mathematics. In further embodiments, the subjects include one or more basic topics including, by way of non-limiting examples, letters, phonics, word families, sight words, numbers, and shapes.

In some embodiments, one or more areas of skill, interest, or expertise are selected from preschool subjects including, by way of non-limiting examples, language arts, mathematics, social studies, science, music, art, and additional languages. In further embodiments, the subjects include one or more preschool topics including, by way of non-limiting examples, citizenship, colors, computer skills, drawing, ethics, geography, music, physical education, poetry, reading, sign language, Spanish, spelling, and U.S. history.

In some embodiments, one or more areas of skill, interest, or expertise are selected from grade school subjects including, by way of non-limiting examples, language arts, mathematics, social studies, science, music and other performing arts, visual arts, additional languages, health, fitness and sports, and information technology. In further embodiments, the subjects include one or more grade school topics including, by way of non-limiting examples, biology, chemistry, citizenship, composition, computer skills, drawing, earth science, ethics, geography, grammar, physical education, poetry, pre-algebra, reading, sign language, spelling, U.S. government, U.S. history, and writing.

In some embodiments, one or more areas of skill, interest, or expertise are selected from middle school subjects including, by way of non-limiting examples, language arts, mathematics, social studies, science, music and other performing arts, visual arts, additional languages, health, fitness and sports, and information technology. In further embodiments, the subjects include one or more middle school topics including, by way of non-limiting examples, algebra, American literature, biology, chemistry, composition, computer skills, drawing, earth science, ethics, geography, geometry, grammar, journalism, photography, physical education, poetry, pre-algebra, reading, spelling, U.S. government, U.S. history, world history, and writing.

In some embodiments, one or more areas of skill, interest, or expertise are selected from high school subjects including, by way of non-limiting examples, language arts, mathematics, social studies, science, music and other performing arts, visual arts, additional languages, health, fitness and sports, and information technology. In further embodiments, the subjects include one or more high school topics including, by way of non-limiting examples, U.S. history, U.S. government, world history, European history, economics, geography, psychology, sociology, anthropology, philosophy, biology, ecology, anatomy, physiology, chemistry, physics, earth science, astronomy, algebra, statistics, geometry, calculus, trigonometry, grammar, spelling, writing, American literature, European literature, English literature, world literature, composition, poetry, drawing, painting, photography, film, theatre, journalism, computer skills, computer science, computer programming, business, physical education, and sign language.

In some embodiments, one or more areas of skill, interest, or expertise are selected from higher education subjects including, by way of non-limiting examples, language arts, mathematics, social studies, science, music and other performing arts, visual arts, additional languages, health, fitness and sports, and information technology. In further embodiments, the subjects include one or more higher education topics including, by way of non-limiting examples, U.S. history, U.S. government, world history, European history, economics, macroeconomics, microeconomics, psychology, sociology, anthropology, philosophy, law, political science, education, urban studies, women's studies, biology, botany, ecology, environmental studies, anatomy, physiology, virology, pharmacology, cell biology, molecular biology, microbiology, genetics, medicine, neuroscience, chemistry, organic chemistry, biochemistry, physical chemistry, biophysics, physics, earth science, astronomy, astrophysics, algebra, statistics, geometry, calculus, trigonometry, electrical engineering, civil engineering, mechanical engineering, chemical engineering, writing, American literature, European literature, English literature, world literature, composition, poetry, music theory, religion, drawing, painting, photography, film, theatre, journalism, computer science, computer programming, business, business administration, accounting, nursing, law enforcement, physical education, and sign language.

In some embodiments, one or more areas of skill, interest, or expertise are selected from language arts topics including, by way of non-limiting examples, phonics, reading, vocabulary, spelling, grammar, writing, composition, public speaking, American literature, world literature, and poetry.

In some embodiments, one or more areas of skill, interest, or expertise are selected from mathematics topics including, by way of non-limiting examples, mathematics, algebra, geometry, calculus, trigonometry, probability, statistics, number theory, applied mathematics, logic, and topology.

In some embodiments, one or more areas of skill, interest, or expertise are selected from social studies topics including, by way of non-limiting examples, political science, law, U.S. government, U.S. history, world history, geography, economics, archaeology, anthropology, sociology, communication, and psychology.

In some embodiments, one or more areas of skill, interest, or expertise are selected from science topics including, by way of non-limiting examples, health, nutrition, biology, ecology, environmental science, meteorology, oceanography, marine biology, hydrology, soil science, botany, anatomy, physiology, virology, pharmacology, cell biology, molecular biology, microbiology, genetics, medicine, pathology, neuroscience, zoology, chemistry, organic chemistry, biochemistry, physical chemistry, materials science, biophysics, physics, optics, earth science, electrical engineering, civil engineering, mechanical engineering, chemical engineering, paleontology astronomy, astrophysics, and computer science.

In some embodiments, one or more areas of skill, interest, or expertise are selected from arts topics including, by way of non-limiting examples, writing, composition, poetry, art, music, music theory, drawing, painting, photography, film, theatre, dance, sculpture, and art history.

In some embodiments, one or more areas of skill, interest, or expertise are selected from languages including, by way of non-limiting examples, English, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, That, Burmese, Malay, Telugu, and Javanese.

In some embodiments, one or more areas of skill, interest, or expertise are selected from health, sports, and fitness topics including, by way of non-limiting examples, health, nutrition, physical education, archery, baseball, basketball, boating, bowling, cheerleading, cricket, cycling, field hockey, football, golf, hiking, ice hockey, lacrosse, martial arts, water polo, rock climbing, roller hockey, rugby, running, skiing, soccer, surfing, swimming, and walking.

In some embodiments, one or more areas of skill, interest, or expertise are selected from information technology topics including, by way of non-limiting examples, computer skills, Internet safety, computer programming, computer networking, and computer science.

In some embodiments, one or more areas of skill, interest, or expertise are selected from professional topics including, by way of non-limiting examples, continuing legal education, continuing medical education, and continuing education for teachers, accountants, tax preparers, physical therapists, occupational therapists, psychologists, nurses, and nurse practitioners.

In some embodiments, one or more areas of skill, interest, or expertise are selected from professional skills including, by way of non-limiting examples, organization, leadership, time management, negotiation, harassment awareness, conflict management, interviewing, and networking.

In some embodiments, one or more areas of skill, interest, or expertise comprise a plurality of levels. In further embodiments, each area of skill, interest, or expertise comprises a plurality of levels. In some of these embodiments, a level comprises educational topics and activities appropriate for a particular developmental stage of a learner. In some embodiments, a level comprises educational topics and activities appropriate for a particular skill level of a learner. In some embodiments, a level comprises educational topics and activities appropriate for a particular educational objective. In other embodiments, a level comprises educational topics and activities appropriate for a particular test or certification. In some of these embodiments, one or more areas of skill, interest, or expertise comprise three, four, five, six, seven, eight, nine, ten, eleven, twelve, or more levels. In one particular embodiment, one or more areas of skill, interest, or expertise comprise six levels. In some embodiments, each area of skill, interest, or expertise comprises three, four, five, six, seven, eight, nine, ten, eleven, twelve, or more levels. In another particular embodiment, each area of skill, interest, or expertise comprises six levels.

### Learning Activities

The educational system assembling platform disclosed herein includes a plurality of learning activities associated with each area of skill, interest, or expertise. In some embodiments, each activity is substantially related to one or more specific areas of skill, interest, or expertise. In some embodiments, each activity teaches toward educational objectives within one or more specific areas of skill, interest, or expertise. In some embodiments, each learning activity in the plurality of learning activities associated with each area of skill, interest, or expertise requires a similar level of skill or knowledge to complete. In other embodiments, the learning activities in the plurality of learning activities associated with each area of skill, interest, or expertise require a range of levels of skill or knowledge to complete. In further embodiments, one or more learning activities requires a range of levels of skill or knowledge.

In further embodiments, the plurality of activities is interconnected by an instructional plan designed to accomplish one or more specific educational objectives through the mutual reinforcement of individual activities. In some embodiments, an instructional plan interconnects two or more activities associated with a subject in such a way that understanding is built progressively with one or more activities adding to the educational messages of one or more previous activities. In further embodiments, an instructional plan is conceived by an instructional designer. In other embodiments, an instructional plan is conceived by a mentor to a learner.

In some embodiments, one or more activities are selected from informal activities including, by way of non-limiting examples, demonstrations, how-to-articles, how-to-videos, and simulations.

In some embodiments, one or more activities are selected from preschool activities including, by way of non-limiting examples, books, games, puzzles, art, and music.

In some embodiments, one or more activities are selected from K-12 activities including, by way of non-limiting examples, books, games, puzzles, art, music, reading assignments, articles, videos, demonstrations, simulations, quizzes, examinations, worksheets, problem sets, brainstorms, and journals.

In some embodiments, one or more activities are selected from higher education activities including, by way of non-limiting examples, books, reading assignments, lectures, articles, videos, demonstrations, simulations, mock examinations, quizzes, examinations, essays, laboratory experiments, problem sets, brainstorms, and journals.

In some embodiments, one or more activities are selected from professional activities including, by way of non-limiting examples, books, articles, brainstorms, collaborations, group activities, multi-player games, videos, lectures, role-plays, simulations, demonstrations, quizzes, and exams.

In some embodiments, one or more activities are available in a language other than English in order to facilitate the education of non-English speaking learners. In other embodiments, one or more activities are available in a language other than English in order to address a language curriculum. In further embodiments, one or more activities are available in one or more languages including, by way of non-limiting examples, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, That, Burmese, Malay, Telugu, and Javanese.

### Software Modules

The educational system assembling platform disclosed herein comprises software modules. In view of the disclosure provided herein, the software modules are created by techniques known to those of skill in the art using machines, software, and languages known to the art. In some embodiments, the software modules are in one computer program. In other embodiments, the software modules are in more than one computer program. In some embodiments, the software modules are hosted on one machine. In other embodiments, the software modules are hosted on more than one machine. In some embodiments, the software modules are hosted on one or more machines in one location. In other embodiments, the software modules are hosted on one or more machines in more than one location.

### Selecting One or More Learners

The educational system assembling platform disclosed herein includes a software module, adapted for use by a mentor, for selecting one or more learners. In view of the disclosure provided herein, the software module is created by techniques known to those of skill in the art using machines, software, and languages known to the art. In some embodiments, to use the software module for selecting one or more learners, a mentor creates an account within the educational system. In further embodiments, the mentor then associates one or more learners with the account. In some embodiments, the mentor associates learners with the account by typing information describing each learner. In other embodiments, the mentor associates learners with the account by uploading a data file containing information describing each learner. In further embodiments, the data file is formatted in a data serialization format known to those in the art including, by way of non-limiting examples, tab-separated values, comma-separated values, character-separated values, delimiter-separated values, XML, JSON, BSON, and YAML.

Referring to FIG. 1, in some embodiments, the mentor is presented with a list of learners 1 for whom the mentor may create a customized sequence of learning activities. In some embodiments, the list of learners comprises names of learners. In further embodiments, the list of learners further comprises icons, such as avatars, associated with learners. In further embodiments, the mentor may select one or more learners for whom the mentor may create a customized sequence of learning activities. In some embodiments, a mentor selects one or more learners based on characteristics such as, previous completion of specific learning activities, performance in previous learning activities, or interests and preferences of the learners.

In some embodiments, a mentor selects learners by selecting elements associated with the learners including, by way of non-limiting examples, text, icons, avatars, or check boxes. In some embodiments, a mentor selects elements associated with learners using a pointing device including, by way of non-limiting examples, a mouse, trackball, track pad, or stylus. In further embodiments, a mentor makes selections with a pointing device by actions including, by way of non-limiting examples, clicking, double clicking, right clicking, shift clicking, control clicking, command clicking, dragging, or drawing a line, circle, or other shape. In some embodiments, a mentor selects elements associated with learners using a touch screen or multi-touch screen. In further embodiments, a mentor makes selections with a touch screen or multi-touch screen by actions including, by way of non-limiting examples, tapping, double tapping, dragging, pinching, or drawing a line, circle, or other shape. In other embodiments, a mentor selects elements associated with learners using a microphone to capture voice or other sound input. In other embodiments, a mentor selects elements associated with activities using a video camera to capture motion or visual input. In some embodiments, a mentor selects learners using a keyboard, or alternative text input device, by typing names of learners or other text associated with learners.

### Selecting Learning Activities

The educational system assembling platform disclosed herein includes a software module, adapted for use by a mentor, for selecting learning activities from among a population of activities to create one or more subpopulations of activities to be completed by a learner. In view of the disclosure provided herein, the software module is created by techniques known to those of skill in the art using machines, software, and languages known to the art. In some embodiments, the software module for selecting learning activities from among a population of activities to create one or more subpopulations of activities to be completed by a learner is available from every section of the educational environment such that a mentor may browse the environment and is free to select any learning activity.

Referring to FIG. 1, in some embodiments, the software module for selecting learning activities is configured to allow said mentor to identify activities by area of skill, interest, or expertise. In further embodiments, a mentor is presented with selectable elements representing groups of learning activities teaching toward learning objectives in one or more areas of skill, interest, or expertise 2. In some embodiments, areas of skill, interest, or expertise including, by way of non-limiting examples, hobbies and personal interests, basic subjects and topics, preschool subjects and topics, grade school subjects and topics, middle school subjects and topics, high school subjects and topics, higher education subjects and topics, language arts topics, mathematics topics, social studies topics, science topics, arts topics, languages, health, sports, and fitness topics, information technology topics, professional topics, and professional skills, described herein. In a particular embodiment, a mentor is presented with selectable elements representing groups of learning activities teaching toward learning objectives in reading, math, science and social studies, and art and colors.

Further referring to FIG. 1, in some embodiments, the software module for selecting learning activities is configured to allow said mentor to identify activities by activity type. In further embodiments, a mentor is presented with selectable elements representing types of activities 3. In some embodiments, activity types include, by way of non-limiting examples, informal activities, preschool activities, K-12 activities, higher education activities, and professional activities, described herein. In a particular embodiment, a mentor is presented with selectable elements representing types of learning activities including music and songs, books, puzzles, and games.

In some embodiments, the software module for selecting learning activities is configured to allow said mentor to identify activities by activity theme. In some embodiments, the software module for selecting learning activities is configured to allow said mentor to identify activities that teach to a particular educational objective. In some embodiments, the software module for selecting learning activities is configured to allow said mentor to identify activities that teach to a particular element of a published educational standard. In some embodiments, the said software module for selecting learning activities is configured to allow said mentor to identify activities by activity duration. In some embodiments, the software module for selecting learning activities is configured to allow said mentor to identify activities by activity level of skill required. In further embodiments, the software module for selecting learning activities is configured to allow said mentor to identify activities by combinations of the criteria described herein.

Referring to FIG. 1, in some embodiments, the software module for selecting learning activities is configured to allow said mentor to identify activities by keyword searching 4. In further embodiments, keywords relate to any of the criteria for identifying learning activities described herein.

In some embodiments, a mentor selects learning activities for inclusion in a subpopulation of activities to be completed by a learner by selecting elements associated with activities including, by way of non-limiting examples, text, icons, or check boxes. Referring to FIG. 1, in some embodiments, a mentor selects learning activities by dragging and dropping activity icons 6 into a designated area 5.

In some embodiments, a mentor selects elements associated with learning activities using a pointing device including, by way of non-limiting examples, a mouse, trackball, track pad, or stylus. In further embodiments, a mentor makes selections with a pointing device by actions including, by way of non-limiting examples, clicking, double clicking, right clicking, dragging, or drawing a line, circle, or other shape. In some embodiments, a mentor selects elements associated with activities using a touch screen or multi-touch screen. In further embodiments, a mentor makes selections with a touch screen or multi-touch screen by actions including, by way of non-limiting examples, tapping, double tapping, dragging, pinching, or drawing a line, circle, or other shape. In other embodiments, a mentor selects elements associated with activities using a microphone to capture voice or other sound input. In other embodiments, a mentor selects elements associated with activities using a video camera to capture motion or visual input. In some embodiments, a mentor selects activities using a keyboard, or alternative text input device, by typing names of activities or other text associated with activities.

In some embodiments, the software module for selecting learning activities is configured to allow a mentor to block one or more activities such that it cannot be accessed by one or more learners. In some embodiments, a mentor selects learning activities for blocking by selecting elements associated with activities including, by way of non-limiting examples, text, icons, or check boxes. Referring to FIG. 1, in some embodiments, a mentor selects learning activities for blocking by dragging and dropping activity icons 6 into a designated area 8. In some embodiments, a mentor selects learning activities for blocking by any of the selection methods described herein.

In some embodiments, the software module for selecting learning activities is configured to allow a mentor to remove one or more activities from a subpopulation of activities. In some embodiments, a mentor selects learning activities for removal from a subpopulation of activities to be completed by a learner by selecting elements associated with activities including, by way of non-limiting examples, text, icons, or check boxes. Referring to FIG. 1, in some embodiments, a mentor removes learning activities by dragging and dropping activity icons 6 into a designated area 9. In some embodiments, a mentor selects learning activities for removal by any of the selection methods described herein. In further embodiments, a mentor removes learning activities by other methods including, by way of non-limiting examples, using a right click menu, unchecking a check box, or using the delete key on a keyboard.

### Subpopulations of Activities

In some embodiments, the educational system assembling platform disclosed herein includes a software module, adapted for use by a mentor, for creating, naming, and saving multiple subpopulations of learning activities associated with one or more learners. In view of the disclosure provided herein, the software module is created by techniques known to those of skill in the art using machines, software, and languages known to the art. In some embodiments, a mentor creates one subpopulation of learning activities from the population of activities. In some embodiments, a mentor creates more than one subpopulation of learning activities from the population of activities. In further embodiments, a mentor creates two, three, four, five, six, seven, eight, nine, ten, eleven, twelve, or more subpopulations of learning activities from the population of activities. In some embodiments, subpopulations of learning activities are associated with one learner. In other embodiments, subpopulations of learning activities are associated with more than one learner. In further embodiments, subpopulations of learning activities are associated with a class of learners. In some embodiments, a subpopulation of activities comprises activities within a lesson. In some embodiments, a subpopulation of activities comprises lessons within a unit. In some embodiments, a subpopulation of activities comprises units in a level of study. In further embodiments, a subpopulation of activities comprises a combination of activities, lessons, and units.

### Organizing Subpopulations of Activities

Referring to FIG. 1, the educational system assembling platform disclosed herein provides a mentor access to a software module to further organize subpopulations of learning activities to be completed by a learner 7. The educational system assembling platform disclosed herein includes a software module, adapted for use by a mentor, for displaying and organizing one or more subpopulations of learning activities. In view of the disclosure provided herein, the software module is created by techniques known to those of skill in the art using machines, software, and languages known to the art.

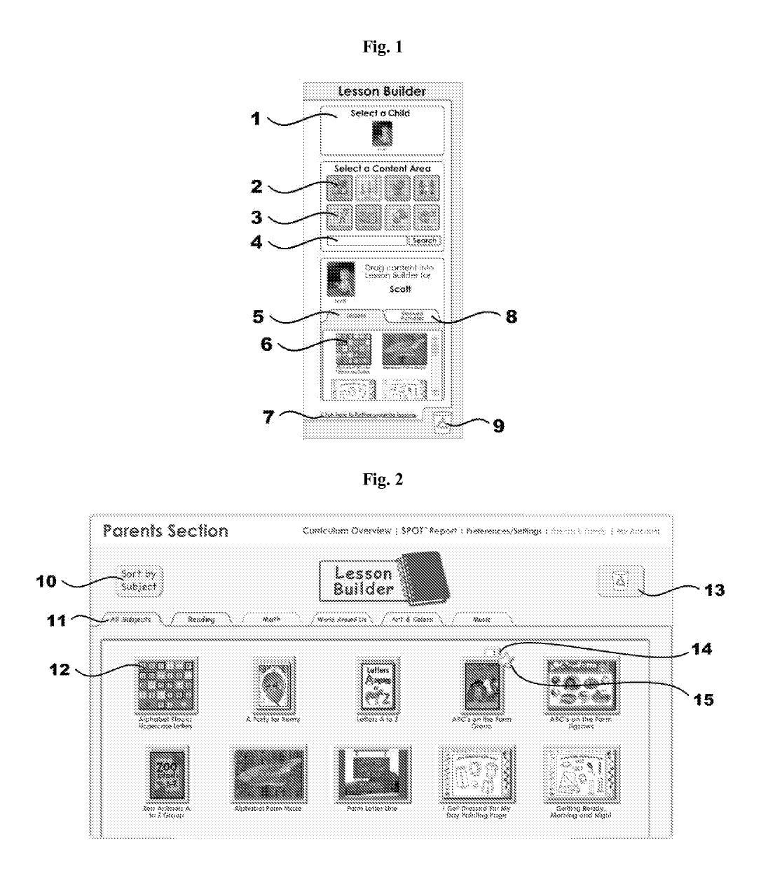

Referring to FIG. 2, in some embodiments, the software module for displaying and organizing one or more subpopulations of learning activities is configured to allow a mentor to sort subpopulations of activities based on each activity's association with one or more areas of skill, interest, or expertise. In further embodiments, a mentor may use a selectable element 10 to activate tabs 11 labeled with one or more areas of skill, interest, or expertise. In still further embodiments, each tab 11, provides access to learning activities within one or more subpopulations of activities associated with an area of skill, interest, or expertise.

In some embodiments, the software module for displaying and organizing one or more subpopulations of learning activities is configured to allow a mentor to sort subpopulations of activities based on the degree to which each activity teaches to a particular educational objective. In some embodiments, the software module for displaying and organizing one or more subpopulations of learning activities is configured to allow a mentor to sort subpopulations of activities based on the degree to which each activity addresses a particular element of a published educational standard.

In some embodiments, the software module for displaying and organizing one or more subpopulations of learning activities is configured to allow a mentor to sequence activities within subpopulations of activities. In some embodiments, the software module for displaying and organizing one or more subpopulations of learning activities is configured to allow a mentor to sequence learning activities within lessons. In some embodiments, the software module for displaying and organizing one or more subpopulations of learning activities is configured to allow a mentor to sequence lessons within learning units. In some embodiments, the software module for displaying and organizing one or more subpopulations of learning activities is configured to allow a mentor to sequence learning units within levels of study. In some embodiments, the software module for displaying and organizing one or more subpopulations of learning activities is configured to allow said mentor to rank or prioritize activities within subpopulations of activities.

In some embodiments, each step in the sequence activities within a subpopulation of activities comprises either an activity or a set of alternate activities. In further embodiments, where the next step in a sequence of activities is a singular activity, the educational system presents the activity to the learner. In further embodiments, where the next step in a sequence of activities is a set of alternate activities, the educational system presents one activity from the set of alternate activities to the learner. In some embodiments, the educational system presents an activity from a set of alternate activities based on, by way of non-limiting examples, the skill level of the learner, the performance of the learner in previously completed activities, input of a mentor to the learner, or the preference of the learner.

Referring to FIG. 2, in some embodiments, a mentor sequences, ranks, or prioritizes learning activities within a subpopulation of activities to be completed by a learner by dragging and dropping activity icons 12 into a spatial order relative to each other. In further embodiments, a mentor sequences, ranks, or prioritizes learning activities within a subpopulation of activities by assigning a number using techniques including, by way of non-limiting examples, typing numbers, using a pull down menu, using a slider control, and using radio buttons.

In some embodiments, the software module for displaying and organizing one or more subpopulations of learning activities is configured to allow said mentor to remove activities from subpopulations of activities. In some embodiments, a mentor selects learning activities for removal from a subpopulation of activities to be completed by a learner by selecting elements associated with activities including, by way of non-limiting examples, text, icons, or check boxes. Referring to FIG. 2, in some embodiments, a mentor removes learning activities by dragging and dropping activity icons 12 into a designated area 13. In some embodiments, a mentor selects learning activities for removal by any of the selection methods described herein. In further embodiments, a mentor removes learning activities by other methods including, by way of non-limiting examples, using a right click menu, unchecking a check box, or using the delete key on a keyboard.

In some embodiments, the software module for displaying and organizing one or more subpopulations of learning activities is configured to display the number of times a learner has completed one or more activities. In some embodiments, the number of times a learner has completed an activity is represented as, by way of non-limiting examples, a number, a percentage, a pie chart, a bar chart, a color, a shade, dots, checkmarks, or variations in size.

Referring to FIG. 2, in some embodiments, the software module for displaying and organizing one or more subpopulations of learning activities is configured to further display a numeric counter 14 indicating number of times a learner has completed each activity. In a particular embodiment, a white star 15 indicates that a learner has completed an activity more than once, but less than five times. In a particular embodiment, a gold star indicates that a learner has completed an activity more than five times. In other embodiments, the software module for displaying and organizing one or more subpopulations of learning activities is configured to display a Boolean indicator of whether or not a learner has completed each activity. In further embodiments, a Boolean indicator is represented as, by way of non-limiting examples, a color, dot, checkmark, outline, border, or size.

### Providing Access to Subpopulations of Activities

The educational system assembling platform disclosed herein includes a software module, adapted for use by a learner, for displaying and providing access to one or more subpopulations of learning activities to be completed by a learner. In view of the disclosure provided herein, the software module is created by techniques known to those of skill in the art using machines, software, and languages known to the art.

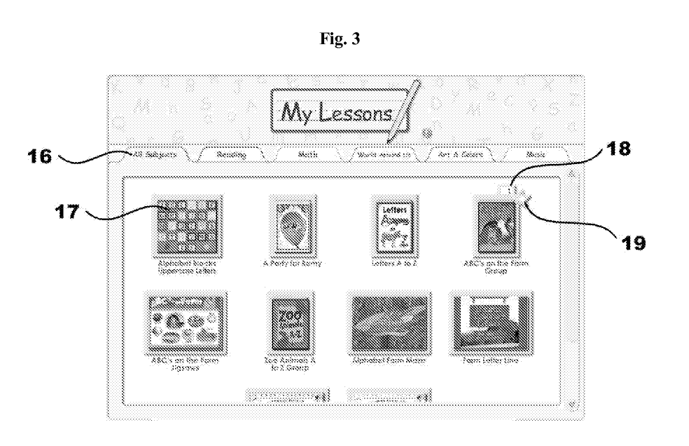

Referring to FIG. 3, in some embodiments, the software module for displaying and providing access to one or more subpopulations of learning activities is configured to allow a learner to sort subpopulations of activities based on each activity's association with one or more areas of skill, interest, or expertise. In further embodiments, a learner may use tabs 16 labeled with one or more areas of skill, interest, or expertise. In still further embodiments, each tab 16, provides access to learning activities within one or more subpopulations of activities associated with an area of skill, interest, or expertise.

In some embodiments, the software module for displaying and providing access to one or more subpopulations of learning activities is configured to allow a learner to sort subpopulations of activities based on the degree to which each activity teaches to a particular educational objective. In some embodiments, the software module for displaying and providing access to one or more subpopulations of learning activities is configured to allow a learner to sort subpopulations of activities based on the degree to which each activity addresses a particular element of a published educational standard.

In some embodiments, the software module for displaying and providing access to one or more subpopulations of learning activities is configured to allow said learner to freely select learning activities from among subpopulations of activities. In further embodiments, a learner has the option to repeat previously completed learning activities. Referring to FIG. 3, in some embodiments, a learner selects learning activities by selecting activity icons associated with learning activities 17.

In further embodiments, a learner selects elements associated with learning activities using a pointing device including, by way of non-limiting examples, a mouse, trackball, track pad, or stylus. In further embodiments, a learner makes selections with a pointing device by actions including, by way of non-limiting examples, clicking, double clicking, right clicking, dragging, or drawing a line, circle, or other shape. In some embodiments, a learner selects elements associated with activities using a touch screen or multi-touch screen. In further embodiments, a learner makes selections with a touch screen or multi-touch screen by actions including, by way of non-limiting examples, tapping, double tapping, dragging, pinching, or drawing a line, circle, or other shape. In other embodiments, a learner selects elements associated with activities using a microphone to capture voice or other sound input. In other embodiments, a learner selects elements associated with activities using a video camera to capture motion or visual input. In some embodiments, a learner selects activities using a keyboard, or alternative text input device, by typing names of activities or other text associated with activities.

In some embodiments, the software module for displaying and providing access to one or more subpopulations of learning activities is configured to require a learner to complete a subpopulation of learning activities in the sequence determined by a mentor. In such embodiments, a learner must complete each preceding activity in the sequence to progress to the next activity. Typically, a mentor selects a sequence of activities such that each activity can build on the educational messages of those prior toward the goal of providing a learner understanding of one or more areas of skill, interest, or expertise. In some embodiments, the sequence of activities is predetermined to prepare a learner for a particular certification or examination. In other embodiments, the sequence of activities is predetermined in accordance with a published educational standard. In further embodiments, a learner has the option to repeat previously completed learning activities without progressing to the next activity in the sequence.

In some embodiments, the software module for displaying and providing access to one or more subpopulations of learning activities is configured to display the number of times said learner has completed each activity. In some embodiments, the number of times a learner has completed an activity is represented as, by way of non-limiting examples, a number, a percentage, a pie chart, a bar chart, a color, a shade, dots, checkmarks, or variations in size.

Referring to FIG. 3, in some embodiments, the software module for displaying and providing access to one or more subpopulations of learning activities is configured to further display a numeric counter 18 indicating number of times a learner has completed each activity. In a particular embodiment, a white star 19 indicates that a learner has completed an activity more than once, but less than five times. In a particular embodiment, a gold star indicates that a learner has completed an activity more than five times. In other embodiments, the software module for displaying and organizing one or more subpopulations of learning activities is configured to display a Boolean indicator of whether or not a learner has completed each activity. In further embodiments, a Boolean indicator is represented as, by way of non-limiting examples, a color, dot, checkmark, outline, border, or size.

In some embodiments, the software module for displaying and providing access to one or more subpopulations of learning activities is configured to allow a learner to optionally remove learning activities from subpopulations of activities based on each activity's association with one or more areas of skill, interest, or expertise. In some embodiments, the software module is configured to allow said learner to optionally remove learning activities from subpopulations of activities based on activity type. In some embodiments, the software module is configured to allow said learner to optionally remove learning activities from subpopulations of activities based on activity theme.

### Monitoring the Progress of One or More Learners

In some embodiments, the educational system assembling platform disclosed herein further comprises a software module, adapted for use by a mentor, for monitoring the progress of one or more learners in completing one or more subpopulations of learning activities. In view of the disclosure provided herein, the software module is created by techniques known to those of skill in the art using machines, software, and languages known to the art. In further embodiments, the software module for monitoring the progress of one or more learners can be disabled by a mentor. In further embodiments, a mentor disables the software module in a settings configuration area of the educational system. In some embodiments, the software module monitors progress of one or more learners in subpopulations of activities representing learning activities within lessons. In some embodiments, the software module monitors progress of one or more learners in subpopulations of activities representing lessons within learning units. In some embodiments, the software module monitors progress of one or more learners in subpopulations of activities representing learning units within levels of study.

In some embodiments, the functionality of the software module for monitoring the progress of one or more learners in completing one or more subpopulations of learning activities is integrated into other software modules such as the module for selecting learning activities and/or the module for displaying and organizing subpopulations of activities. In some embodiments, the functionality of the software module for monitoring the progress of one or more learners in completing one or more subpopulations of learning activities is represented separately.

In some embodiments, the software module for monitoring the progress of a learner in completing one or more subpopulations of activities includes a visual indicator adapted for use by a learner, wherein said visual indicator displays the percentage of activities completed within a subpopulation of activities. In further embodiments, the visual indicator represents percentage of activities completed within a subpopulation of activities as, by way of non-limiting examples, a percentage, a bar chart, a pie chart, a color that changes in correlation with percentage, a shade that changes in correlation with percentage, dots, checkmarks, or size of an icon that changes in correlation with percentage.

In some embodiments, the software module for monitoring the progress of a learner in completing one or more subpopulations of activities includes progress displays adapted for use by a learner or a mentor to a learner. In some embodiments, the progress displays indicate percentage completion of one or more subpopulations of activities. In further embodiments, the progress displays indicate completion of one or more activities associated with each subpopulation of activities. In still further embodiments, the progress displays indicate the number of times a learner has completed one or more activities. In some embodiments, the progress displays indicate performance in one or more subpopulations of activities. In further embodiments, the progress displays indicate performance in one or more activities associated with each subpopulation of activities. In some embodiments, the progress displays indicate performance via, by way of non-limiting examples, raw scores or percentages. Some embodiments might also indicate performance by metrics such as grades. In some embodiments, the progress displays indicate time spent in one or more subpopulations of activities. In further embodiments, the progress displays indicate time spent in one or more activities associated with each subpopulation of activities. In still further embodiments, the progress displays indicate completion of one or more subpopulations of activities that teach to a particular educational objective, performance in one or more subpopulations of activities that teach to a particular educational objective, and time spent in one or more subpopulations of activities that teach to a particular educational objective. In still further embodiments, the progress displays indicate completion of one or more subpopulations of activities that address a particular element of a published educational standard, performance in one or more subpopulations of activities that address a particular element of an educational standard, and time spent in one or more subpopulations of activities that address a particular element of a published educational standard.

In some embodiments, the software module for monitoring the progress of a learner in completing one or more subpopulations of activities includes printable reports adapted for use by a learner or a mentor to a learner.

### EXAMPLES

The following illustrative examples are representative of embodiments of the educational system described herein and are not meant to be limiting in any way.

### Example 1

### Mentor Guided Learning Unit

An educational system assembling platform is constructed using a laptop computer connected to an intranet computer network and a computer program delivered to the computer via the network. The computer program includes executable instructions that create an educational environment. The educational environment includes approximately 550 learning activities teaching toward educational objectives in world history and includes a mentor guided learning mode. The mentor guided learning mode includes a software module for use by a mentor in selecting one or more learners, a software module for use by a mentor in selecting learning activities from among the population of learning activities to create one or more subpopulations of activities to be completed by a learner, and a software module for displaying one or more subpopulations of learning activities to a learner and providing access to them. The mentor guided learning mode also includes a software module for use by a mentor in further organizing subpopulations of learning activities and in monitoring the progress of a learner in completing each subpopulation of activities.

A secondary school teacher uses the educational system assembling platform to create a uniquely sequenced world history learning unit for a high school student. The teacher creates an account within the educational system and associates 105 students with her account. The teacher selects a single student and creates, names, and saves six lessons. She then uses keyword searching to identify learning activities teaching toward educational objectives related to the rise of the Roman Empire, the emperor Tiberius, the Battle of Alesia, the emperor Vespasian, the Roman Senate, and the decline of the Western Roman Empire. When she finds a relevant learning activity, she uses her computer mouse to click, drag, and drop an icon associated with the activity into a designated area to add it to the appropriate lesson. She populates each of the six lessons with five learning activities. She then further organizes each lesson by dragging and dropping the activity icons to sequence the activities within each lesson. She uses the same technique to further sequence the lessons within the unit. The student uses the educational system to view and participate in the activities in the sequence that his teacher created; however, the student finds a favorite activity on Vercingetorix, which he intermittently completes many times. Each day, the teacher uses a progress display to view which of the activities and lessons the student completes and how much time he spends on each

### Example 2

### Mentor Guided, Branched, and Sequenced Set of Learning Units

An educational system assembling platform is constructed using a laptop computer connected to an intranet computer network and a computer program delivered to the computer via the network. The computer program includes executable instructions that create an educational environment. The educational environment includes approximately 550 learning activities teaching toward educational objectives in world history and includes a mentor guided learning mode. The mentor guided learning mode includes a software module for use by a mentor in selecting one or more learners, a software module for use by a mentor in selecting learning activities from among the population of learning activities to create one or more subpopulations of activities to be completed by a learner, and a software module for displaying one or more subpopulations of learning activities to a learner and providing access to them. The mentor guided learning mode also includes a software module for use by a mentor in further organizing subpopulations of learning activities and in monitoring the progress of a learner in completing each subpopulation of activities.

A middle school mathematics teacher uses the educational system assembling platform to create a branched, sequenced set of learning units for her 7th grade algebra class. She uses the learner selection function to select those of her students who scored less than 70% on the mid-term examination, and creates a subpopulation of activities organized into lessons and learning units for those students. In creating this subpopulation of activities, the teacher selects from the total population by filtering against specific educational objectives and published educational standards that were represented by questions on the examination that were most often missed. The teacher organizes the subpopulation of activities into a branched sequence of lessons, such that the exact path of individual students depends on their performance in certain of the activities. As students move through this sequence, the teacher monitors progress according to the specific educational objectives of the activities as they are completed as well as the length of time required to complete activities, and notices that activities which involve fractional coefficients seem to take much longer for roughly half of the students than comparable activities which do not address that specific educational objective. She then modifies the sequence so as to provide those specific students with activities that offer extra instruction and practice with regard to that objective, having selected such activities by filtering the entire population against that specific educational objective.

What is claimed is:

1. An educational system assembling platform comprising:
(a) a digital processing device connected to a computer network comprising an operating system configured to perform executable instructions, a central processing unit, a memory device, a display, an input device, and a sound output device;
(b) a computer program, provided to said digital processing device, including executable instructions that create an educational environment, wherein said educational environment comprises: at least one area of skill, interest, or expertise; a plurality of learning activities associated with each area of skill, interest, or expertise; and, a mentor guided learning mode comprising:
i. a software module for selecting one or more learners, wherein said software module is adapted for a mentor;
ii. a software module for selecting learning activities from among said population of activities to create one or more subpopulations of activities to be completed by a learner, wherein said software module is adapted for a mentor; and
iii. a software module for displaying and providing access to one or more subpopulations of learning activities to be completed by a learner, wherein said software module is adapted for a learner.

2. The educational system assembling platform of claim 1, further comprising a software module for creating, naming, and saving multiple subpopulations of learning activities associated with one or more learners, wherein said software module is adapted for a mentor.

3. The educational system assembling platform of claim 1, further comprising a software module for monitoring the progress of a learner in completing one or more subpopulations of activities, wherein the software module is adapted for a mentor.

4. The educational system assembling platform of claim 1, wherein the system is for a child aged about 1 year to about 10 years.

5. The educational system assembling platform of claim 1, wherein the system is for a child aged about 2 years to about 6 years.

6. The educational system assembling platform of claim 1, further comprising a software module for displaying and organizing one or more subpopulations of learning activities, wherein said software module is adapted for a mentor.

7. The educational system assembling platform of claim 6, wherein said software module for displaying and organizing one or more subpopulations of learning activities is configured to allow said mentor to sequence activities within subpopulations of activities.

8. The educational system assembling platform of claim 6, wherein said software module for displaying and organizing one or more subpopulations of learning activities is configured to allow said mentor to rank or prioritize activities within subpopulations of activities.

9. The educational system assembling platform of claim 7, wherein each step in the sequence activities comprises either an activity or a set of alternate activities.

10. The educational system assembling platform of claim 9, wherein the educational system presents an activity from a set of alternate activities based on criteria such as the skill level of the learner, the performance of the learner in previously completed activities, input of a mentor to the learner, or the preference of the learner.

11. The educational system assembling platform of claim 6, wherein said software module for displaying and organizing one or more subpopulations of learning activities is configured to allow said mentor to sort subpopulations of activities based on each activity's association with one or more areas of skill, interest, or expertise.

12. The educational system assembling platform of claim 6, wherein said software module for displaying and organizing one or more subpopulations of learning activities is configured to allow said mentor to sort subpopulations of activities based on the degree to which each activity teaches to a particular educational objective.

13. The educational system assembling platform of claim 6, wherein said software module for displaying and organizing one or more subpopulations of learning activities is configured to allow said mentor to sort subpopulations of activities based on the degree to which each activity addresses a particular element of a published educational standard.

14. The educational system assembling platform of claim 6, wherein said software module for displaying and organizing one or more subpopulations of learning activities is configured to display the number of times said learner has completed each activity.

15. The educational system assembling platform of claim 1, wherein said software module for selecting learning activities is configured to allow said mentor to identify activities by area of skill, interest, or expertise.

16. The educational system assembling platform of claim 1, wherein said software module for selecting learning activities is configured to allow said mentor to identify activities by activity type.

17. The educational system assembling platform of claim 1, wherein said software module for selecting learning activities is configured to allow said mentor to identify activities by activity theme.

18. The educational system assembling platform of claim 1, wherein said software module for selecting learning activities is configured to allow said mentor to identify activities that teach to a particular educational objective.

19. The educational system assembling platform of claim 1, wherein said software module for selecting learning activities is configured to allow said mentor to identify activities that teach to a particular element of a published educational standard.

20. The educational system assembling platform of claim 1, wherein said software module for selecting learning activities is configured to allow said mentor to identify activities by activity duration.

21. The educational system assembling platform of claim 1, wherein said software module for selecting learning activities is configured to allow said mentor to identify activities by activity level of skill required.

22. The educational system assembling platform of claim 1, wherein said software module for selecting learning activities is configured to allow said mentor to identify activities by keyword searching.

23. The educational system assembling platform of claim 1, wherein said software module for selecting learning activities is configured to allow said mentor to select one or more learners based on characteristics of the learners such as, previous completion of specific learning activities, performance in previous learning activities, or interests and preferences of the learners.

24. The educational system assembling platform of claim 1, wherein said software module for selecting learning activities is configured to allow said mentor to block one or more activities.

25. The educational system assembling platform of claim 1, wherein said software module for displaying and providing access to one or more subpopulations of learning activities is configured to allow said learner to sort subpopulations of activities based on each activity's association with one or more areas of skill, interest, or expertise.

26. The educational system assembling platform of claim 1, wherein said software module for displaying and providing access to one or more subpopulations of learning activities is configured to allow said learner to sort subpopulations of activities based on the degree to which each activity teaches to a particular educational objective.

27. The educational system assembling platform of claim 1, wherein said software module for displaying and providing access to one or more subpopulations of learning activities is configured to allow said learner to sort subpopulations of activities based on the degree to which each activity addresses a particular element of a published educational standard.

28. The educational system assembling platform of claim 1, wherein said software module for displaying and providing access to one or more subpopulations of learning activities is configured to allow said learner to freely select learning activities from among subpopulations of activities.

29. The educational system assembling platform of claim 28, wherein said learner has the option to repeat previously completed learning activities.

30. The educational system assembling platform of claim 7, wherein said software module for displaying and providing access to one or more subpopulations of learning activities is configured to require said learner to complete a subpopulation of learning activities in the sequence determined by said mentor.

31. The educational system assembling platform of claim 30, wherein said learner has the option to repeat previously completed learning activities.

32. The educational system assembling platform of claim 1, wherein said software module for displaying and providing access to one or more subpopulations of learning activities is configured to allow said learner to optionally remove learning activities from subpopulations of activities based on each activity's association with one or more areas of skill, interest, or expertise.

33. The educational system assembling platform of claim 1, wherein said software module for displaying and providing access to one or more subpopulations of learning activities is configured to allow said learner to optionally remove learning activities from subpopulations of activities based on activity type.

34. The educational system assembling platform of claim 1, wherein said software module for displaying and providing access to one or more subpopulations of learning activities is configured to allow said learner to optionally remove learning activities from subpopulations of activities based on activity theme.

35. The educational system assembling platform of claim 3, wherein said software module for monitoring the progress of a learner in completing one or more subpopulations of activities includes a visual indicator adapted for use by a learner, wherein said visual indicator displays the percentage of activities completed within a subpopulation of activities.

36. The educational system assembling platform of claim 3, wherein said software module for monitoring the progress of a learner in completing one or more subpopulations of activities includes progress displays adapted for use by a learner or a mentor to a learner.

37. The educational system assembling platform of claim 36, wherein said progress displays indicate percentage completion of one or more subpopulations of activities and/or completion of each activity associated with each subpopulation of activities.

38. The educational system assembling platform of claim 36, wherein said progress displays indicate performance in one or more subpopulations of activities and/or performance in each activity associated with each subpopulation of activities.

39. The educational system assembling platform of claim 36, wherein said progress displays indicate time spent in one or more subpopulations of activities and/or time spent in each activity associated with each subpopulation of activities.

40. The educational system assembling platform of claim 36, wherein said progress displays indicate one or more of: completion of one or more subpopulations of activities that teach to a particular educational objective, performance in one or more subpopulations of activities that teach to a particular educational objective, and time spent in one or more subpopulations of activities that teach to a particular educational objective.

41. The educational system assembling platform of claim 36, wherein said progress displays indicate one or more of completion of one or more subpopulations of activities that address a particular element of a published educational standard, performance in one or more subpopulations of activities that address a particular element of an educational standard, and time spent in one or more subpopulations of activities that address a particular element of a published educational standard.

42. The educational system assembling platform of claim 3, wherein said software module for monitoring the progress of a learner in completing one or more subpopulations of activities includes printable reports adapted for use by a learner or a mentor to a learner.

43. Computer readable media encoded with a computer program including instructions executable by a digital processing system for delivering content to create an educational environment, wherein said educational environment comprises: at least one area of skill, interest, or expertise; a plurality of learning activities associated with each area of skill, interest, or expertise; and, a mentor guided learning mode comprising:
i. a software module for selecting one or more learners, wherein said software module is adapted for a mentor;
ii. a software module for selecting learning activities from among said population of activities to create one or more subpopulations of activities to be completed by a learner, wherein said software module is adapted for a mentor; and
iii. a software module for displaying and providing access to one or more subpopulations of learning activities to be completed by a learner, wherein said software module is adapted for a learner.

44. A method of facilitating the educational development of a learner comprising the step of:
(a) providing executable instructions to a digital processing device comprising an operating system configured to perform executable instructions, a memory device, a display, an input device, and a sound output device, to create an educational environment, wherein said educational environment comprises: at least one area of skill, interest, or expertise; a plurality of learning activities associated with each area of skill, interest, or expertise; and, a mentor guided learning mode comprising:
i. a software module for selecting one or more learners, wherein said software module is adapted for a mentor;
ii. a software module for selecting learning activities from among said population of activities to create one or more subpopulations of activities to be completed by a learner, wherein said software module is adapted for a mentor; and
iii. a software module for displaying and providing access to one or more subpopulations of learning activities to be completed by a learner, wherein said software module is adapted for a learner.
